(19) United States
(12) Patent Application Publication
(10) Pub. No.: US 2018/0226745 A1
(43) Pub. Date: Aug. 9, 2018

(54) WIRE COVER MEMBER

(71) Applicant: Sumitomo Wiring Systems, Ltd., Yokkaichi, Mie (JP)

(72) Inventor: Shinji Hirano, Yokkaichi (JP)

(21) Appl. No.: 15/749,131

(22) PCT Filed: Jul. 19, 2016
(86) PCT No.: PCT/JP2016/071116

§ 371 Date: Jan. 31, 2018

(30) Foreign Application Priority Data
Aug. 5, 2015 (JP) 2015-154800

(51) Int. Cl. H01R 13/585; H01R 13/56

(52) U.S. Cl. CPC H01R 13/585; H01R 13/56

(57) ABSTRACT

A wire cover member disclosed by this specification is a wire cover member (10) to be mounted on a connector (50) from which wires (W) are pulled out rearwardly, and includes a pair of half covers (20) having a wire inserting portion (22) through which the wires (W) pulled out rearwardly from the connector (50) are inserted, a fixing portion (40) made of synthetic resin and to be accommodated into the wire inserting portion (22) with a tiny clearance defined between the fixing portion and the wire inserting portion while being fixed to the wires (W), and a corrugated tube (30) formed to be resiliently contractible in a front-rear direction and held in the wire inserting portion (22) in a state where the fixing portion (40) can come into contact with the corrugated tube (30) from front.

### BACKGROUND

### Field of the Invention

This specification relates to a wire cover.

### Description of the Related Art

Japanese Unexamined Patent Publication No. H11-67329 discloses a wire cover to be mounted on a connector provided on an end of a wire. This wire cover includes two half covers divided into two along a wire pulled out from the connector, and a resilient holding portion to be mounted into the half covers. The wire cover is mounted on the connector by sandwiching a wire pull-out portion of the connector where the wire is pulled out from both sides by the half covers.

The resilient holding portion is made of a rubber material. When the connector is sandwiched from both sides by the half covers, the wire pulled out from the connector is sandwiched resiliently by the resilient holding portion. In this way, vibration transmitted along the wire and a pulling force pulling the wire are absorbed by the resilient holding portion to suppress the transmission of vibration to a terminal connected to the end of the wire and a pulling force applied to the wire.

The wire is sandwiched by the resilient holding portion made of the rubber material according to the above-described connector. Thus, if a strong force is applied to the wire, the wire is pulled to slip in the resilient holding portion and a strong impact force acts on the wire. Accordingly, a trouble may occur in a connecting part of the wire and the terminal.

A structure for suppressing an impact force applied to a wire is disclosed in this specification.

### SUMMARY

This specification is directed to a wire cover to be mounted on a connector from which a wire is pulled out rearwardly. The wire cover includes a wire inserting portion, and the wire pulled out rearwardly from the connector is inserted through the wire inserting portion. The wire cover further includes a fixing portion made of synthetic resin. The fixing portion is accommodated in the wire inserting portion displaceably in an inserting direction of the wire while being fixed to the wire. A biasing member is formed to be resiliently contractible in the inserting direction of the wire and is held in the wire inserting portion in a state where the fixing portion is capable of contacting the biasing member from the front.

According to the wire cover thus configured, when the wire is pulled strongly and a strong force is applied thereto, the fixing portion made of synthetic resin and fixed to the wire comes into contact with the biasing member from the front to be biased forward, and a pulling force is absorbed by the biasing member. Thus, for example, as compared to the case where a fixing member is made of rubber, an impact force applied to the wire can be suppressed while a displacement of the fixing portion relative to the wire is suppressed.

The biasing member may be formed into a tubular shape covering the wire over the entire circumference while being open in an extending direction of the wire, and the fixing portion may come into contact with an opening edge part of the biasing member over the entire circumference. According to this configuration, an impact applied to the wire can be absorbed uniformly over the entire circumference. In this way, the impact applied to the wire can be prevented from concentrating on a part of the wire, as compared to the case where the fixing portion comes into contact with the biasing member in a biased manner.

The biasing member may be a corrugated tube for protecting the wire drawn out from the wire inserting portion over the entire circumference, and the corrugated tube may be locked in the inserting direction of the wire by a holding projection provided in the wire inserting portion.

According to this configuration, the fixing portion can be biased by the corrugated tube locked and fixed by the holding projection provided in the wire inserting portion. That is, since the corrugated tube for protecting the wire can double as the biasing member for biasing a fixing member, an increase in the number of components can be prevented and the enlargement of the wire inserting portion can be prevented as compared to the case where a biasing member is provided separately in the wire inserting portion.

According to the technique disclosed by this specification, it is possible to suppress an impact force applied to a wire.

### BRIEF DESCRIPTION OF DRAWINGS

FIG. 1 is a plan view showing a state where a wire cover member is mounted on a connector.

FIG. 2 is a side view showing the state of FIG. 1.

FIG. 3 is a plan view partly in section showing the state where the wire cover member is mounted on the connector.

FIG. 4 is a vertical section showing the state where the wire cover member is mounted on the connector.

FIG. 5 is a vertical section, corresponding to a cross-section of FIG. 4, showing a state where a wire is pulled rearwardly.

### DETAILED DESCRIPTION

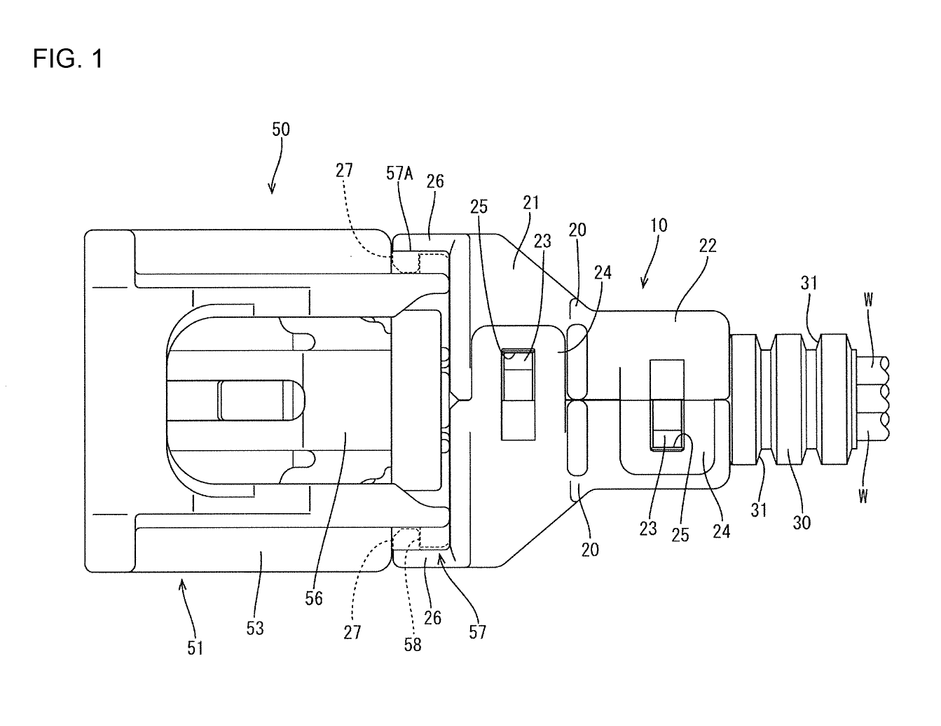

One embodiment of the invention is described with reference to FIGS. 1 to 5.

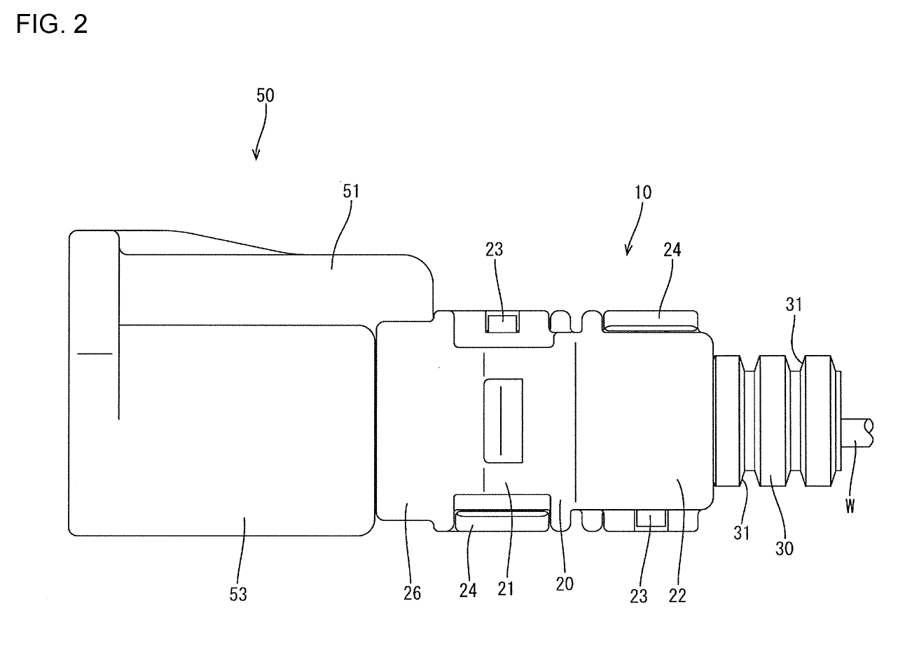

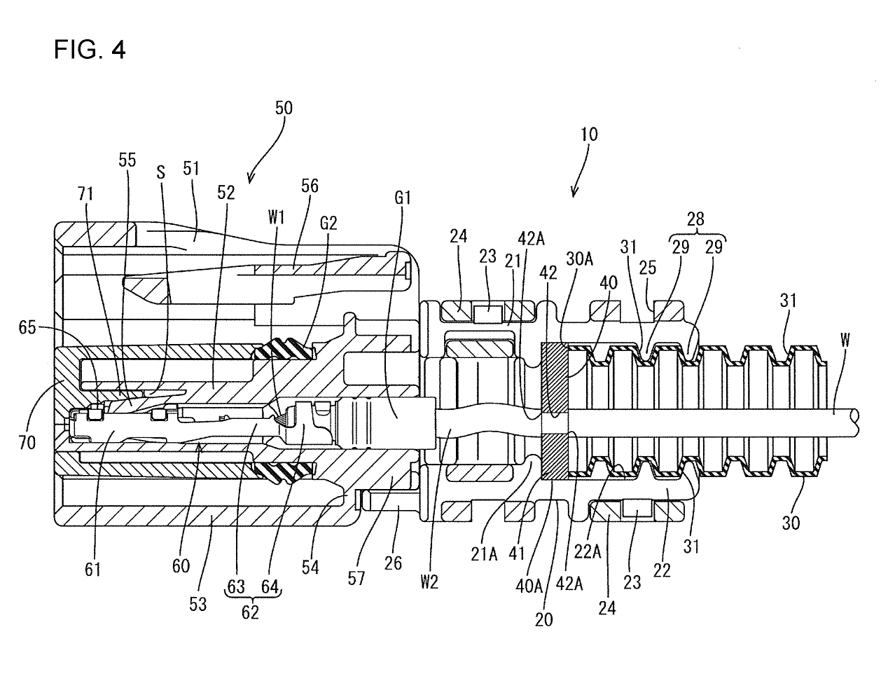

A wire cover 10 to be mounted on a connector 50 is illustrated in this embodiment. Note that, in the following description, a vertical direction is based on that in FIGS. 1 and 4. Further, a front-rear direction is based on that in FIGS. 1 and 2, wherein shown left and right sides are referred to as front and rear sides.

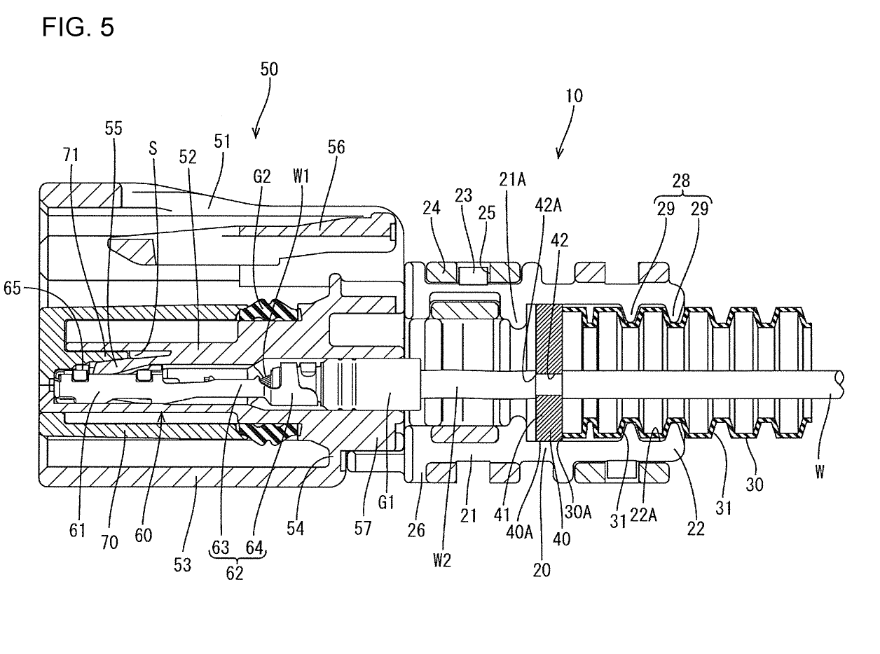

As shown in FIGS. 4 and 5, the connector 50 includes a housing 51 made of synthetic resin and a plurality of female terminals 60 held in the housing 51 while being connected to ends of wires W.

Each female terminal 60 is formed such that a wire fixing portion 62 is provided behind a connecting portion 61 in the form of a box long in the front-rear direction. An unillustrated tab-shaped male terminal is insertable into the connecting portion 61 from the front, and the male terminal and the connecting portion 61 are connected electrically by inserting the male terminal into the connecting portion 61. On the other hand, the wire fixing portion 62 has a wire barrel 63 crimped to a core W1 exposed at the end of the wire W and an insulation barrel 64 crimped to a rubber plug G1 externally fit on the wire W are connected in the front-rear direction. The female terminal 60 is connected electrically to the wire W by crimping the wire barrel 63 to the core W1, and the rubber plug G1 is fixed to the end of the wire W together with the female terminal 60 by crimping the insulation barrel 64 to the rubber plug G1.

As shown in FIGS. 4 and 5, the housing 51 is formed such that a terminal accommodating portion 52 for accommodating the female terminals 60 is covered externally by a forwardly open receptacle 53.

The terminal accommodating portion 52 is in the form of a tower extending straight from a back wall 54 of the receptacle 53 to a position slightly behind the front end opening of the receptacle 53, and a rubber ring G2 is mounted on the outer periphery of the terminal accommodating portion 52. Female terminals 60 are inserted side by side in a lateral direction in the terminal accommodating portion 52. Each female terminal 60 is retained in the terminal accommodating portion 52 so as not to come out rearward by locking a locked projection 65 on an upper part of the connecting portion 61 from behind by a resiliently displaceable locking lance 55 cantilevered in the terminal accommodating portion 52. Further, a front cap 70 is mounted on the terminal accommodating portion 52 from the front, and restricting pieces 71 provided in the front cap 70 enter deflection spaces S for the locking lances 55. Thus, resilient displacements of the locking lances 55 are restricted and the female terminals 60 are locked doubly.

The receptacle 53 externally covers the terminal accommodating portion 52 over the entire periphery, and a lock arm 56 is provided on an upper part of the receptacle 53 for holding an unillustrated mating connector and the connector 50 in a connected state by locking the mating connector.

A wire pull-out portion 57 is provided in a rear part of the receptacle 53. and the wires W connected to the respective female terminals 60 in the terminal accommodating portion 52 are pulled out rearwardly from the wire pull-out portion 57. The rubber plugs G1 externally fit on the wires W are accommodated in the wire pull-out portion 57, and the penetration of water and the like into the terminal accommodating portion 52 from the wire pull-out portion 57 is prevented by the close contact of the rubber plugs G1 with the inner peripheral surface of the wire pull-out portion 57.

As shown in FIG. 1, the wire cover 10 includes two half covers 20 made of synthetic resin and dividable along the front-rear direction, which is a pull-out direction of the wires W. The cover 10 also includes a corrugated tube 30 made of synthetic resin and to be fixed to the half covers 20 while covering the wires W.

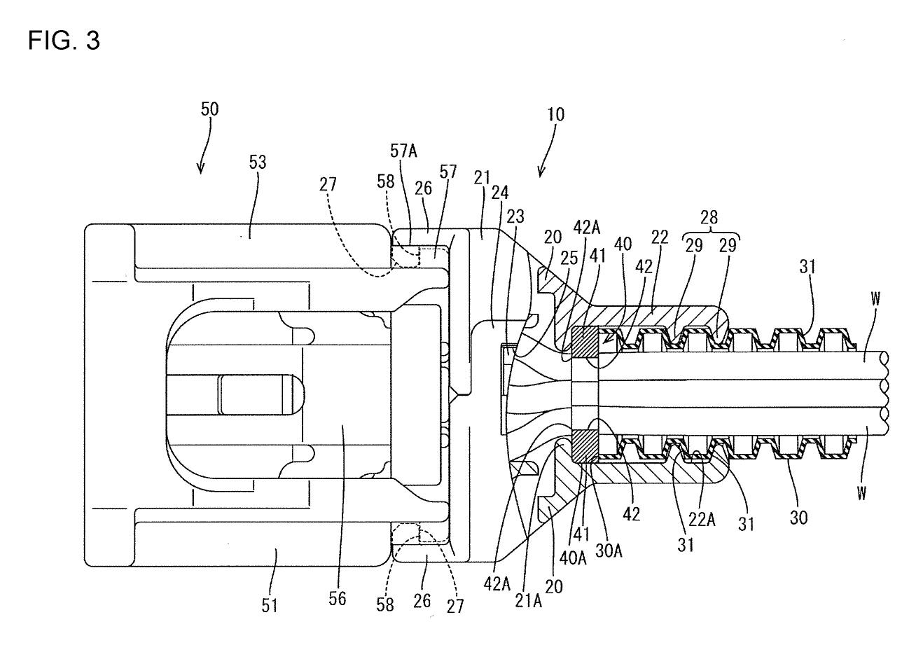

As shown in FIGS. 1 and 3, the half covers 20 in a state assembled with each other are such that a rectangular tubular wire inserting portion 22 is connected to and behind a box-shaped widened portion 21 that is widened toward both lateral sides as it extends forward. The half covers 20 are mountable on the wire pull-out portion 57 in the connector 50.

As shown in FIG. 2, an engaging projection 23 projects on one of upper and lower surfaces of the widened portion 21 of each half cover 20, and an engaging piece 24 is provided on the other surface and is resiliently displaceable toward a vertically outer side. The engaging piece 24 is provided with an engaging hole 25 into which the engaging projection 23 can fit. When the half covers 20 are assembled with each other, the engaging projection 23 on one half cover 20 is fit into the engaging hole 25 of the engaging piece 24 on the other half cover 20 to lock the engaging piece 23 and the engaging piece 24 in the lateral direction, as shown in FIG. 1. Thus the pair of half covers 20 are held assembled with each other.

Further, as shown in FIG. 2, an engaging projection 23 projects on one of upper and lower surfaces of the wire inserting portion 22 in each half cover 20 and an engaging piece 24 is provided on the other surface similarly to the widened portion 21. The engaging piece 24 is resiliently displaceable toward a vertically outer side. The half covers 20 are held assembled with each other by assembling the half covers 20 with each other and locking the engaging pieces 23 and the engaging pieces 24 in the lateral direction.]

Further, as shown in FIGS. 2, 4 and 5, the engaging projection 23 on the wire inserting portion 22 is formed on the upper or lower surface surfaces of the half cover 20 that is different from the one where the engaging projection 23 of the widened portion 21 is formed. The arrangement of the engaging pieces 24 and the engaging projections 23 is set to be vertically opposite in the widened portion 21 and the wire inserting portion 22 when the half covers 20 are assembled.

Specifically, as shown in FIGS. 1 and 3, the widened portion 21 is configured into a box shape by assembling the half covers 20 together, and two forwardly extending locking pieces 26 are formed on both lateral end parts of the widened portion 21. The locking pieces 26 are in the form of flat plates extending in the vertical direction, and locking claws 27 project in on the tips of the locking pieces 26. These locking claws 27 can fit into locked recesses 58 formed by recessing side surfaces 57A on both lateral sides of the wire inserting portion 57 from both widthwise sides. The locking claws 27 fit into the locked recesses 58 when the half covers 20 are assembled with each other to fix the half covers 20 to the wire inserting portion 57 so as not to come off.

As shown in FIGS. 3 to 5, the wire inserting portion 22 communicates with the inside of the widened portion 21 and is open rearward. The wires W pulled out rearwardly from the wire pull-out portion 57 are collectively insertable into the wire inserting portion 22 in the front-rear direction. By assembling the half covers 20 with each other to sandwich the wires W from both lateral sides, the wires W pulled out rearwardly from the wire pull-out portion 57 are inserted into the wire inserting portion 22.

As shown in FIGS. 3 to 5, a tube fixing portion 28 for fixing the corrugated tube 30 is provided in a rear part of the wire inserting portion 22. The tube fixing portion 28 includes holding projections 29 having a substantially triangular cross-section and projecting inwardly of the wire inserting portion 22 from an inner peripheral wall 22A of the wire inserting portion 22, and the respective holding projections 29 are arranged while being spaced apart in the front-rear direction.

As shown in FIGS. 3 to 5, the corrugated tube 30 has a substantially hollow cylindrical shape to collectively cover the wires W pulled out rearwardly from the wire inserting portion 22, and is in the form of bellows having circumferential grooves 31 provided on an outer peripheral surface while being spaced apart in the front-rear direction. An interval between the grooves 31 adjacent in the front-rear direction is equal to an interval of the holding projections 29 in the front-rear direction in the tube fixing portion 28 of the wire inserting portion 22. The holding projections 29 of the tube fixing portion 28 can fit into the grooves 31 over the entire circumference. That is, by fitting the holding projections 29 in the tube fixing portion 28 into the grooves 31 on an end of the corrugated tube 30 and assembling and fixing the pair of half covers 20 with each other, the corrugated tube 30 is fixed to the half covers 20 while being pulled out rearwardly from the wire inserting portion 22.

Further, as shown in FIG. 5, the corrugated tube 30 is accommodated at a position slightly forward of the tube fixing portion 28 in the wire inserting portion 22, and the corrugated tube 30 pulled out rearwardly from the wire inserting portion 22 protects the respective wires W so that the wires W are not exposed to outside.

Further, as shown in FIGS. 3 to 5, the corrugated tube 30 is resiliently contractible in the front-rear direction, which is an inserting direction of the wires W, by squeezing and deforming the groove portions 31 in the front-rear direction, and can be bent in an arbitrary direction in which the wires W are routed by deforming each groove 31 in the front-rear direction.

The wire cover 10 includes a fixing portion 40 made of synthetic resin and to be accommodated into the wire inserting portion 22 of the half covers 20 while being fixed to the wires W.

The fixing portion 40 is configured by causing end surfaces of two half plates 41 in the form of substantially rectangular flat plates somewhat thick in the front-rear direction to butt against each other, and the outer peripheral shape of the fixing portion 40 conforms to the inner peripheral shape of the wire inserting portion 22. A recess 42 into which the wires W are rather press-fit is formed in the butting surface of each half plate 41. The recess 42 is long in the lateral direction and, as shown in FIGS. 3 to 5, a vertical direction thereof is slightly smaller than an outer diameter dimension of the wire W and a lateral dimension thereof is set to be slightly smaller than the sum of the outer diameter dimensions of the wires W pulled out from the wire pull-out portion 57.

Accordingly, if the wires W are press-fit into the recesses 42 and the fixing portion 40 is configured by causing the butting surfaces of the pair of half plates 41 to butt against each other, corners 42A of the recesses 42 of the half plates 41 bite into coatings W2 of the respective wires W and the wires W are surrounded collectively by the fixing portion 40 so that the fixing portion 40 is fixed firmly to the wires W.

Further, as shown in FIGS. 3 and 4, the fixing portion 40 is accommodated in front of the corrugated tube 30 in the wire inserting portion 22 while giving an extra length to the wires W pulled out from the wire pull-out portion 57, and is stopped in front by a front stop 21A provided in a rear end part of the widened portion 21.

The front stop 21A projects inward of the widened portion 21 from the inner surface of the widened portion 21, and the fixing portion 40 is retained in the wire inserting portion 22 by the front stop 21A coming into contact with an outer peripheral edge part of the fixing portion 40 over the entire circumference from the front.

Further, when the fixing portion 40 is accommodated into the wire inserting portion 22, a tiny clearance is defined between an outer peripheral end surface 40A of the fixing portion 40 and the inner peripheral wall 22A of the wire inserting portion 22 and the fixing portion 40 is in contact with a front end opening edge 30A of the corrugated tube 30 over the entire circumference from the front, as shown in FIGS. 3 and 4. That is, the fixing portion 40 is accommodated in the wire inserting portion 22 while being sandwiched in the front-rear direction by the front stop portion 21A and the corrugated tube 30.

Next, the assembling of the wire cover member 10 and the procedure of mounting the wire cover member 10 on the connector 50 are briefly described and functions and effects of the wire cover member 10 are described.

In mounting the wire cover member 10 on the connector 50 from which the wires W are pulled out rearwardly, the wires W are first fit into the recesses 42 in the half plates 41 of the fixing portion 40 and the fixing portion 40 is configured by causing the half plates 41 to butt against each other. When the fixing portion 40 is configured, the corner parts 42A of the recesses 42 of the half plates 41 bite into the coatings W2 of the wires W and the fixing portion 40 is fixed firmly fixed to the wires W.

When the fixing portion 40 is fixed to the wires W, the half covers 20 are assembled with each other to sandwich the fixing portion 40, the wires W and the end of the corrugated tube 30 collectively covering the wires W from both lateral sides.

In this process of assembling the pair of half covers 20, the holding projections 29 in the tube fixing portion 28 are fit into the grooves 31 of the corrugated tube 30 and the fixing portion 40 is accommodated into the wire inserting portion. When the half covers 20 are assembled with each other, the engaging projections 23 and the engaging pieces 24 of the widened portion 21 and the wire inserting portion 22 are locked in the lateral direction so that the half covers 20 are held assembled with each other. Further, if the half covers 20 are held assembled with each other, the corrugated tube 30 is fixed to the wire inserting portion 22 and the fixing portion 40 is accommodated into the wire inserting portion 22 while being sandwiched in the front-rear direction by the front stop portion 21A and the corrugated tube 30.

Further, by fitting the locking claws 27 of the locking pieces 26 in the widened portion 21 into the locked recesses 58 of the wire pull-out portion 57 in the process of assembling the half covers 20 with each other, the half covers 20 are fixed to the wire pull-out portion 57 and the wire cover 10 is mounted on the connector 50.

If a strong rearward pulling force is applied to the wire W pulled out rearward from the wire cover 10 in the connector 50 having the wire cove 10 mounted thereon, a strong impact force is applied to the wire W. Thus, a trouble may occur in a connecting part of the wire W and the wire fixing portion 62 of the female terminal 60.

However, according to this embodiment, if a strong pulling force is applied to the wire W, the fixing portion 40 firmly fixed to bite into the coatings W2 of the wires W is displaced rearwardly in the wire inserting portion 22 and the fixing portion 40 is pressed against the front end opening edge part 30A of the corrugated tube 30 from the front. Then, the corrugated tube 30 disposed forward of the tube fixing portion 28 in the wire inserting portion 22 is contracted resiliently to squeeze the grooves 31, so that the outer peripheral edge part of the fixing portion 40 is biased forward over the entire circumference. That is, the corrugated tube 30 uniformly biases the outer peripheral edge of the fixing portion 40 forward, and the pulling force applied to the wire W is absorbed uniformly by an outer peripheral part of the wire W and the impact force applied to the wire W can be suppressed. In this way, trouble does not occur in the connecting part of the wire W and the wire fixing portion 62 of the female terminal 60 due to the application of the strong impact force to the wire W.

As described above, according to this embodiment, the fixing portion 40 can be fixed firmly fixed to bite into the respective wires W and the fixing portion 40 firmly fixed to the wires W can be biased forward by the corrugated tube 30 for protecting the wires W. Specifically, the corrugated tube 30 for protecting the wires W can double as a biasing member for biasing the fixing portion 40. Thus, an increase in the number of components can be prevented and impact forces applied to the wires W can be suppressed while the enlargement of the wire inserting portion 22 is prevented as compared to the case where a separate biasing member is provided in addition to the corrugated tube 30. Further, the fixing portion 40 made of synthetic resin is fixed to bite into the wires W. Thus, the slip of the fixing portion 40 relative to the wires W can be prevented.

Further, since the outer peripheral edge part of the fixing portion 40 surrounding the wires W over the entire circumference is biased forward over the entire circumference by the front end opening edge part 30A of the corrugated tube 30. Thus, the outer peripheral edge part of the fixing portion 40 can be biased uniformly and a pulling force applied to each wire W can be absorbed uniformly, for example, as compared to the case where a part of the outer peripheral edge part of the fixing portion 40 is biased forward. In this way, an impact force applied to the wire W can be substantially distributed uniformly to each wire W and the concentration of the pulling force on some wire(s) W can be suppressed.

The invention is not limited to the above described and illustrated embodiment. For example, the following various modes also are included.

In the above embodiment, the fixing portion 40 is configured in the form of a plate. However, there is no limitation to this and the fixing portion may be configured in the form of a block thick in the front-rear direction.

In the above embodiment, the fixing portion 40 is configured to be biased forward by the corrugated tube 30. However, there is no limitation to this and a biasing member for biasing the fixing portion 40 forward may be separately provided in the wire inserting portion 22.

In the above embodiment, the corrugated tube 30 is configured in the form of bellows including the grooves 31 on the outer peripheral surface. However, there is no limitation to this and the corrugated tube may be configured to include no groove on the outer peripheral surface if the corrugated tube is contractible in the front-rear direction and capable of biasing the fixing portion 40 forward.

In the above embodiment, the wire cover 10 is configured to be mounted on the connector 50 in which the female terminals 60 are accommodated in the housing 51. However, there is no limitation to this and the wire cover disclosed in this specification may be applied to a male connector in which male terminals are accommodated in a housing.

### LIST OF REFERENCE SIGNS

10: wire cover
22: wire inserting portion
29: holding projection
30: corrugated tube (biasing member)
40: fixing portion
50: connector
W: wire

1. A wire cover to be mounted on a connector from which a wire is pulled out rearwardly, comprising:
a wire inserting portion, the wire pulled out rearwardly from the connector being inserted through the wire inserting portion;
a fixing portion made of synthetic resin, the fixing portion being accommodated in the wire inserting portion displaceably in an inserting direction of the wire while being fixed to the wire; and
a biasing member formed to be resiliently contractible in the inserting direction of the wire, the biasing member being held in the wire inserting portion in a state where the fixing portion is held in contact with the biasing member from front;
the biasing member being configured to bias the fixing portion forward when the wire is pulled rearwardly.

2. The wire cover of claim 1, wherein:
the biasing member is formed into a tubular shape covering the wire over the entire circumference while being open in an extending direction of the wire; and
the fixing portion comes into contact with an opening edge part of the biasing member over the entire circumference.

3. The wire cover of claim 1, wherein:
the biasing member is a tubular corrugated tube for protecting the wire drawn out from the wire inserting portion over the entire circumference; and
the corrugated tube is locked in the inserting direction of the wire by a holding projection provided in the wire inserting portion.

4. The wire cover of claim 1, wherein:
the biasing member is a tubular corrugated tube for protecting the wire drawn out from the wire inserting portion over the entire circumference; and
the corrugated tube is locked in the inserting direction of the wire by a holding projection provided in the wire inserting portion.
